(19) United States
(12) Patent Application Publication
(10) Pub. No.: US 2023/0276745 A1
(43) Pub. Date: Sep. 7, 2023

(54) THERMALLY BONDING TYPE HORTICULTURAL BINDER AND CONTROL METHOD THEREFOR

(71) Applicants: Sang Ki SEO, Daejeon (KR); UVA TOOLS Co,LTD, Daejeon (KR)

(72) Inventors: Hae Young SEO, Daejeon (KR); Sang Ki SEO, Daejeon (KR)

(73) Assignees: Sang Ki SEO, Daejeon (KR); UVA TOOLS Co,LTD, Daejeon (KR)

(21) Appl. No.: 18/304,818

(22) Filed: Apr. 21, 2023

Related U.S. Application Data
(63) Continuation of application No. PCT/KR2021/014504, filed on Oct. 18, 2021.

(30) Foreign Application Priority Data
Oct. 22, 2020 (KR) 10-2020-0137292

(51) Int. Cl. A01G 9/12; B65B 13/32; B65B 13/02

(52) U.S. Cl. CPC A01G 9/128; B65B 13/327; B65B 13/025

(57) ABSTRACT

A heat fusion-type horticultural binder includes: an operation sensor detecting a binding operation in which the handle frame and the arm are pressed; and the power supply device controlled to supply power for a heating wire to the fusion heating wire during the binding operation detected by the operation sensor [symbol] wherein the power supply device includes a power conversion unit generating power for a heating wire to be supplied to the fusion heating wire from a battery, a heating wire driving unit controlled to supply the generated power for a heating wire to the fusion heating wire or cut off the power supply [symbol] and a controller controlling the heating wire driving unit to supply power for a heating wire to the fusion heating wire for a predetermined fusion time during the binding operation.

### CROSS-REFERENCE TO RELATED APPLICATION

This application is a continuation of International Patent Application No. PCT/KR2021/014504, filed on Oct. 18, 2021, which claims benefit of priority to Korean Patent Application No. 10-2020-0137292 [symbol] filed on Oct. 22, 2020 in the Korean Intellectual Property Office, the disclosure of which is incorporated herein by reference in its entirety.

### BACKGROUND

### 1. Field

The present disclosure relates to a heat fusion-type horticultural binder and a control method thereof, and more particularly, a heat fusion-type horticultural binder and a control method thereof, capable of increasing a speed of a binding operation, maintaining a constant binding strength, and minimizing the use of a battery per binding operation by adjusting a time for supplying power to a heat-fused wire according to tape binding conditions.

### 2. Description of Related Art

As horticultural crops, such as fruits, vegetables, and flowers, or specific agricultural crops grow gradually from young seedlings, stems or branches may be broken by the weight of branches and fruits or rain and wind and stems may even sink into the ground. In order to prevent this, props may be set up at appropriate intervals, support lines may be installed therebetween, and the stem or branches of crops may be tied and fixed to the props and the support lines.

In a horticultural binder disclosed in Patent Document 1 for such fixation, when an operator [symbol] while holding a tape guide and a handle, presses the handle and tightens an arm once, a tip of a tape drawn out of a tape container through the tape guide may be caught by a hook lever and a pressure lever of a head installed at the arm, and in this state, when the tape guide and the arm are opened, the tape caught by the hook lever and the pressure lever is pulled out, the operator may hang and wind the tape on the branches of the crops, the props, or the support lines and tighten the arm by pressing the tape guide and the handle with a stronger force than before, so that both ends of the tape wound on the branches of crops and the props or the support lines may be bonded by staples of the stapler and simultaneously cut by a cutter installed on a handle frame. However, since the configuration of bonding both ends of the tape uses the stapler, various problems may arise due to the staples used in the stapler method.

A horticultural binder that improves the problems of Patent Document 1 is proposed in Patent Document 2. A heat fusion-type horticultural binder of Patent Document 2 includes a taper instead of the stapler that supplies the staples, so that the tape formed of a synthetic resin may be partially melted by heat without staples and both ends of the tape may be bonded to each other, thereby solving the problems of the horticultural binder of Patent Document 1. However, the heat fusion method of Patent Document 2 requires an operation of heating a heating wire for heat fusion of the tape, and when the horticultural binder is used in a state in which the heating wire is not sufficiently heated, there is a problem in that the tape is not well bonded. In addition, fusion quality may vary depending on the binding operation and battery conditions, and a binding speed and battery usage efficiency are not taken into consideration.

### SUMMARY

An aspect of the present disclosure may provide a heat fusion-type horticultural binder and a control method thereof [symbol] capable of increasing a speed of a binding operation, maintaining a constant binding strength, and minimizing the use of a battery per binding operation by adjusting a time for supplying power to a heat-fused wire according to tape binding conditions.

The technical problems to be achieved by the present disclosure are not limited to the technical problems mentioned above, and other technical problems not mentioned will be clearly understood by those skilled in the art from the description below.

According to an aspect of the present disclosure, a heat fusion-type horticultural binder including a handle frame, a tape guide attached to the handle frame and including a tape container in which a tape is mounted, a taper rotatably installed on the handle frame and including a fusion heating wire unit including a fusion heating wire receiving a constant current from a power supply device, an arm rotatably installed on the handle frame and including a clincher installed at an end portion facing the taper, and a head installed in the arm and catching and drawing out the tape, includes: an operation sensor detecting a binding operation in which the handle frame and the arm are pressed; and the power supply device controlled to supply power for a heating wire to the fusion heating wire during the binding operation detected by the operation sensor, wherein the power supply device includes a control module including a power conversion unit generating power for a heating wire to be supplied to the fusion heating wire from a battery [symbol] a heating wire driving unit controlled to supply the generated power for a heating wire to the fusion heating wire or cut off the power supply, and a controller controlling the heating wire driving unit to supply power for a heating wire to the fusion heating wire for a predetermined fusion time during the binding operation.

When the binding operation and a previous binding operation are continuous operations having a time interval less than a reference time, the controller may control the heating wire driving unit to supply power for a heating wire to the fusion heating wire for a first time, and when the binding operation and the previous binding operation are not the continuous operations, the controller may control the heating wire driving unit to supply power for a heating wire to the fusion heating wire for a second time longer than the first time.

When a voltage of the battery is equal to or greater than a reference voltage, the controller may control the heating wire driving unit to supply power for a heating wire to the fusion heating wire for a third time, and when the voltage of the battery is less than the reference voltage, the controller may control the heating wire driving unit to supply power for a heating wire to the fusion heating wire for a fourth time longer than a third time.

When a voltage of the battery is equal to or greater than a reference voltage, the controller may control the heating wire driving unit to supply power for a heating wire to the fusion heating wire for a third time, and when the voltage of the battery is less than the reference voltage, the controller may control the heating wire driving unit to supply power for a heating wire to the fusion heating wire for a fourth time longer than the third time, wherein the third time may be the first time when the binding operation is a continuous operation, and the third time may be the second time when the binding operation is not a continuous operation.

The power supply device may further include: an electric wire electrically connecting the control module to the fusion heating wire; and a power switch turning on the power supply device, wherein the controller supplies power for a heating wire to the fusion heating wire for a predetermined preheating time after the power switch is turned on.

The control module may further include a timer controlled to count the fusion time and preheating time.

The taper may include: a tapered frame including a holder recess on one side; a fusion heating wire unit including the fusion heating wire receiving power for a heating wire from the power supply device; and a holder [symbol] to which the fusion heating wire unit is detachably coupled, inserted into the holder recess [symbol] wherein the fusion heating wire faces the clincher and fuses both ends of the tape introduced between the fusion heating wire and the clincher by heat.

The fusion heating wire may have a predetermined resistance value, and the controller may control the power conversion unit to set a magnitude of the power for a heating wire according to the resistance value of the fusion heating wire.

The fusion heating wire may have a predetermined resistance value, and the controller may control the timer to set the fusion time according to the resistance value of the fusion heating wire.

According to another aspect of the present disclosure, a method for controlling a heat fusion-type horticultural binder includes: a binding operation detecting operation of detecting a binding operation in which the handle frame and the arm are pressed; and a heat fusion operation of thermally heat-fusing the tape by supplying power for a heating wire to the fusion heating wire for the predetermined fusion time during the bonding operation according to a detection result of the bonding operation.

The heat fusion operation may include: a continuous operation determining operation of determining whether the binding operation and a previous binding operation are continuous operations having a time interval less than or equal to a reference time; a first time fusion operation of heat-fusing the tape by supplying power for a heating wire to the fusion heating wire for a first time when the binding operation and the previous binding operation are continuous operations; and a second time fusion operation of heat-fusing the tape by supplying power for a heating wire to the fusion heating wire for a second time longer than the first time when the binding operation and the previous binding operation are not continuous operations.

The heat fusion operation may include: a battery voltage determining operation of detecting whether a voltage of the battery is greater than or equal to a reference voltage; a third time fusion operation of heat-fusing the tape by supplying power for a heating wire to the fusion heating wire for a third time when the voltage of the battery is equal to or greater than the reference voltage; and a fourth time fusion operation of heat-fusing the tape by supplying power for a heating wire to the fusion heating wire for a fourth time longer than the third time when the voltage of the battery is less than the reference voltage.

The heat fusion operation may include: a battery voltage determining operation of detecting whether a voltage of the battery is greater than or equal to a reference voltage; a third time fusion operation of heat-fusing the tape by supplying power for a heating wire to the fusion heating wire for a third time when the voltage of the battery is equal to or greater than the reference voltage; and a fourth time fusion operation of heat-fusing the tape by supplying power for a heating wire to the fusion heating wire for a fourth time longer than a third time when the voltage of the battery is less than the reference voltage, wherein the third time is the first time when the binding operation is a continuous operation, and the third time is the second time when the binding operation is not a continuous operation.

The power supply device may further include: an electric wire electrically connecting the control module to the fusion heating wire; and a power switch turning on the power supply device, wherein the method may further include: a preheating operation of preheating by supplying power for a heating wire to the fusion heating wire for a predetermined preheating time after the power switch is turned on.

The method may further include: a resistance value measuring operation of measuring a predetermined resistance value of the fusion heating wire; and a power setting operation of setting a magnitude of the power for a heating wire according to the resistance value of the fusion heating wire.

The method may further include: a resistance value measuring operation of measuring a predetermined resistance value of the fusion heating wire; and a fusion time setting operation of setting the fusion time according to the resistance value of the fusion heating wire.

In the heat fusion-type horticultural binder and the control method thereof according to the embodiments, by adjusting a time for supplying power to a heat-fused wire according to tape binding conditions [symbol] a speed of a binding operation may be increased, a constant binding strength may be maintained, and the use of a battery per binding operation may be minimized.

### BRIEF DESCRIPTION OF DRAWINGS

The above and other aspects, features, and other advantages of the present disclosure will be more clearly understood from the following detailed description taken in conjunction with the accompanying drawings [symbol] in which:

FIG. 1 is an overall plan view of a heat fusion-type horticultural binder according to the present disclosure.

FIG. 2 is an exploded view of a handle frame and a taper of the present disclosure.

FIG. 3 is a block diagram illustrating a control module of the present disclosure.

FIG. 4 is a flowchart illustrating a control method of a heat fusion-type horticultural binder of the present disclosure.

FIG. 5 is a detailed flowchart illustrating an embodiment of a heat fusion operation.

FIG. 6 is a detailed flowchart illustrating another embodiment of a heat fusion operation.

### DETAILED DESCRIPTION

Embodiments of the present disclosure will be described in detail with reference to the accompanying drawings. The following detailed description is merely illustrative and merely illustrates embodiments of the present disclosure.

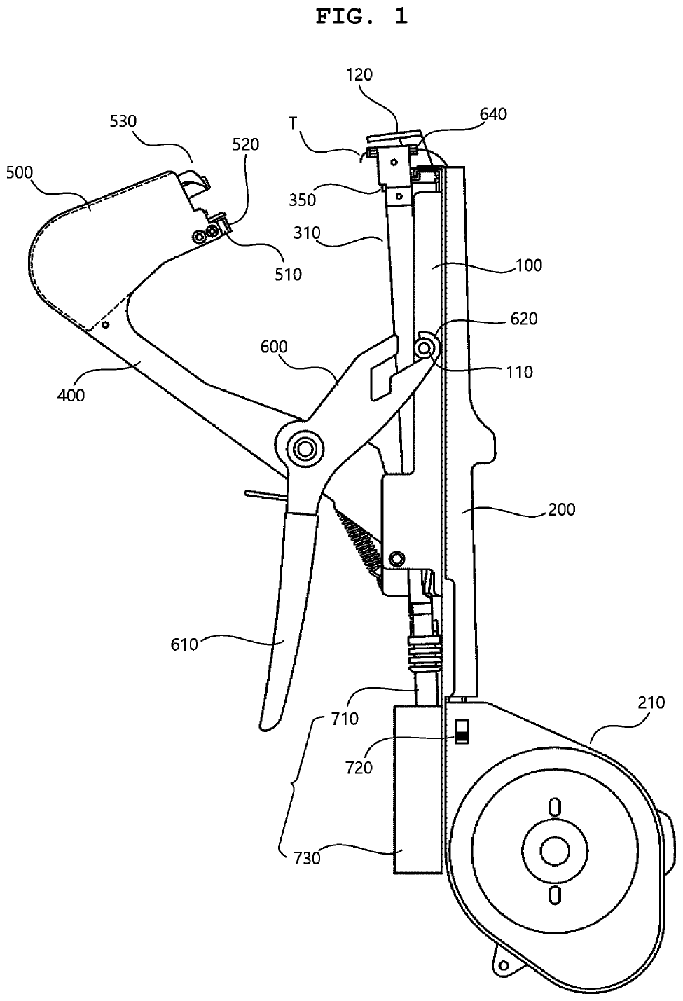

FIG. 1 is an overall plan view of a heat fusion-type horticultural binder according to the present disclosure.

Referring to FIG. 1 [symbol] the present disclosure relates to a heat fusion-type horticultural binder for tying stems and branches to props and support lines in an electrical heat-fusion manner so that horticultural or agricultural crops may grow rightly, which may include a handle frame 100 [symbol] a tape guide 200 attached to the handle frame 100 and including a tape container 210 in which a tape T is mounted, a taper 310 rotatably installed on the handle frame 100 and including a fusion heating wire unit 350 including a fusion heating wire 340 receiving a constant current from a power supply device 700, an arm 400 rotatably installed on the handle frame 100 and including a clincher 510 installed at an end portion facing the taper 310, and a head 500 installed in the arm 400 and catching and drawing out the tape T.

In addition, the heat fusion-type horticultural binder of the present disclosure may include an operation sensor 370 detecting a binding operation in which the handle frame 100 and the arm 400 are pressed and the power supply device 700 controlled to supply power for a heating wire to the fusion heating wire 340 during the binding operation detected by the operation sensor 370, and the power supply device 700 may include a control module 730 including a power conversion unit 735 generating power for a heating wire to be supplied to the fusion heating wire 340 from a battery 734, a heating wire driving unit 736 controlled to supply the generated power for a heating wire to the fusion heating wire 340 or cut off the power supply, and a controller 731 controlling the heating wire driving unit 736 to supply power for a heating wire to the fusion heating wire 340 during a predetermined fusion time during the binding operation.

Through this configuration, the fusion heating wire 340 faces the clincher 510 and mutually fuses both ends of the tape T introduced between the fusion heating wire 340 and the clincher 510 by heat to bind the stems and branches of the horticultural or agricultural crops to the props and support lines.

The operation of the heat fusion-type horticultural binder to tie crops according to the present disclosure will be described in more detail.

Referring to FIG. 1 [symbol] in the handle frame 100 of the heat-sealed horticultural binder according to the present disclosure, pins 110 protrude from both sides of a middle portion, and a stopper 120 may protrude outwardly from a tip portion. In addition, the tape guide 200 is provided with a tape container 210 on one side thereof and may be attached to a bottom surface of the handle frame 100. A tape reel (not shown) is accommodated in the tape container 210. The tape T is unwound from the accommodated tape reel, guided through the inside of the tape guide 200, and drawn toward the head 500 of the arm 400 through a tape lead portion 640. In addition, a lower end of the arm 400 is rotatably installed below the handle frame 100, and the clincher 510 is installed at an upper end portion facing the taper 310. In the above configuration, the head 500 is embedded in an upper portion of the arm 400, and a tape traction portion 530 rotates to catch and draw out the front end portion of the tape T. In addition, a link 600 is rotatably installed on the arm 400, includes a handle 610 gripped by an operator's hand on one side thereof, and includes a hook 620 on the other side thereof so that a pin 110 of the handle frame 100 may be bound to the hook 620.

In addition, in the clincher 510 according to the present disclosure, even when the fusion heating wire 340 is located only on a corresponding surface of the fusion heating wire 340, a certain level of pressing force may be applied to both ends of the tape T, thereby solving the problem of the horticultural binder of the related art in which a staple supplied in a stapler and a staple recess of the clincher 510 configured in the arm 400 need to exactly match for the staple to appropriately fuse the both ends of the tape T.

The clincher 510 according to the present disclosure may include an incombustible member 520 that is less deformed and damaged even by heat generated from the fusion heating wire 340 on a surface of the taper 310 facing the fusion heating wire 340. Here [symbol] the incombustible member 520 may be an incombustible elastic member having a certain elasticity to accommodate a certain portion of the fusion heating wire 340 and both ends of the tape T pressed by the clincher 510 to correspond to a clincher 510 direction when the arm 400 is tightened by pressing the handle 610.

In this configuration, when the operator slightly tightens the arm 400 once by pressing the handle 610, while gripping the tape guide 200 and the handle 610 by hand, a front end of the tape T drawn out from the tape container 210 through the tape guide 200 is captured by the tape traction portion 530, and in this state, when the arm is opened by releasing a pressing force of the handle 610, the tape T captured by the tape traction portion 530 of the head 500 is pulled out and drawn out. Thereafter, when the operator hangs and winds the tape on the branches of the crops, the props or the support lines and performs a binding operation of tightening the arm 400 by pressing the handle with a stronger force than before, the clincher 510 is pressed to the taper 310 and both ends of the tape T wound on the branches or the crops, the props, or the support lines are mutually fused by heat generated by the fusion heating wire 340 of the fusion heating wire unit 350, and at the same time, the tape T is cut by a cutter C installed in the handle frame 100. At this time, the binding operation may be detected by an operation sensor 370 to be described below, and when the binding operation is detected by the operation sensor 370 [symbol] the power supply device 700 may supply power for a heating wire to the fusion heating ire 340 so that fusion may proceed for a predetermined fusion time.

In this manner, the tape T is wound on the branches of crops, props, or the support lines of crops and fused with heat generated by the fusion heating wire 340, and is cut by the cutter C, so that the branches of the crops may be tied with the tape T to the props or the support lines.

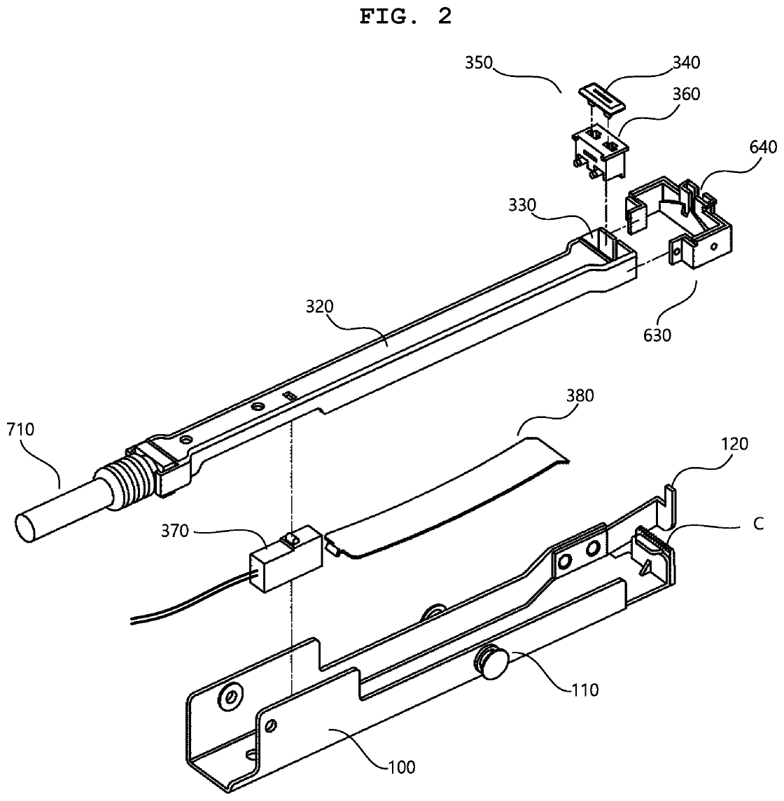

FIG. 2 is an exploded view illustrating a coupling relationship between the handle frame 100 and the taper 310 of the present disclosure.

Referring to FIG. 2, in the present disclosure, the taper 310 may include a tapered frame 320 including a holder recess 330 on one side thereof, a fusion heating wire unit 350 including a fusion heating wire 340 receiving power for a heating wire for a heat fusion from the power supply device 700 through an electric wire 710, and a holder 360, to which the fusion heating wire unit 350 is detachably attached, inserted into the holder recess 330. Here, the fusion heating wire 340 faces the clincher 510 to fuse both ends of the tape T inserted between the fusion heating wire 340 and the clincher 510 by heat.

In the heat fusion-type horticultural binder of the present disclosure, the holder recess 330 on one side of the tapered frame 320 (a direction in which the head 500 is configured) may be a component supplying a current to the heating wire unit that supplies heat and allowing the holder 360 to be inserted therein to allow the heating wire unit to be stably detachably attached. At this time, a head corresponding unit 630 including the tape lead portion 640 may be bonded to the outside of the holder recess 330 of the tapered frame 320 so that the tape traction portion 530 of the head 500 may reliably catch [symbol] lead, and draw out the tape T supplied from the tape lead portion 640 when the handle 610 is pressed.

In addition, the fusion heating wire 340 of the fusion heating wire unit 350 receiving a constant current from the power supply device 700 has a predetermined resistance, and generates heat when a predetermined current is supplied from the power supply device 700, and when a predetermined current is supplied from the power supply device 700, the fusion heating wire 340 may generate heat to melt a portion of the tape T formed of a synthetic resin material, thereby exhibiting an effect of firmly fusing both ends of the tape T with adhesion of the synthetic resin generated in the melted portion.

In addition, the fusion heating wire unit 350 including the fusion heating wire 340 may be configured to be detachably attached to the holder 360, so that electrodes of the fusion heating wire unit 350 may be inserted into a power socket including a positive electrode and a negative electrode provided in the holder 360, respectively, to simply receive power from the holder 360 connected to the power supply device 700 through the electric wire 710, and when the fusion heating wire 340 is cut off while in use, the fusion heating wire unit 350 may be separated from the holder 360 and easily replaced, much like replacing a fuse.

In this manner, compared to the horticultural binder of the related art including a stapler using staples in which staples need to be continuously supplied for continuous use and the work should be stopped if the staples are bent and caught in the stapler during use or used up, in the heat fusion method using the fusion heating wire 340, both ends of the tape T may be fused by melting a portion of the tape T formed of a synthetic resin material by heat without staples [symbol] and thus, the tape T may be thin and conveniently used, compared to method of bonding both ends of the tape T using staples.

According to FIG. 2, the heat fusion-type horticultural binder according to the present disclosure may further include an operation sensor 370 capable of detecting a binding operation of the tapered frame 320 to the fusion heating wire 340 with the handle frame 100 together with the power supply device 700. Specifically, if a current is continuously supplied to the fusion heating wire 340 from the turned-on power supply device 700, the battery 734 may be unnecessarily consumed and the life of the fusion heating wire 340 may be shortened, so preferably, the operation sensor 370 for detecting the binding operation is provided to supply power for a heating wire generated by the power supply device 700 to the fusion heating wire 340.

In the heat fusion-type horticultural binder according to the present disclosure, the operation sensor 370 may be configured between the tapered frame 320 and the handle frame 100 so that the operation sensor 370 is disposed to detect a binding operation in which the handle frame 100 and the arm 400 are pressed due to a pressing force applied by the operator to the handle 610 to fuse both ends of the tape T.

In addition, the heat fusion-type horticultural binder of the present disclosure may further include an elastic member between the tapered frame 320 and the handle frame 100 as shown in FIG. 2. Here, the elastic member may buffer a portion of the pressing force applied to the handle 610 by the operator to fuse the both ends of tape T to prevent damage to the clincher 510 and the fusion heating wire unit 350 due to excessive pressing force, and when the operation sensor 370 is configured between the tapered frame 320 and the handle frame 100 [symbol] the operation sensor 370 may detect the binding operation by the pressing force, and when the pressing force is released, the detecting operation of the operation sensor 370 may be released by the elastic member.

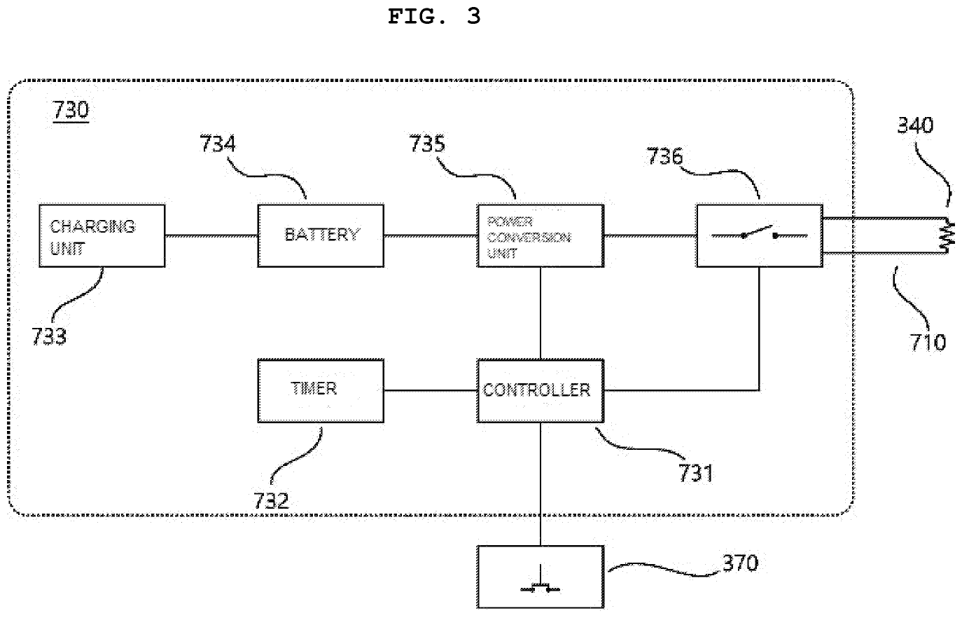

The power supply device 700 of the present disclosure is configured to be controlled to supply power for a heating wire to the fusion heating wire 340 during the binding operation detected by the operation sensor 370, and may include a control module 730, an electric wire 710 electrically connecting the control module 730 to the fusion heating wire 340, and a power switch 720 turning on the power supply device 700. A configuration and operation thereof will be described in detail with reference to FIGS. 3 to 6.

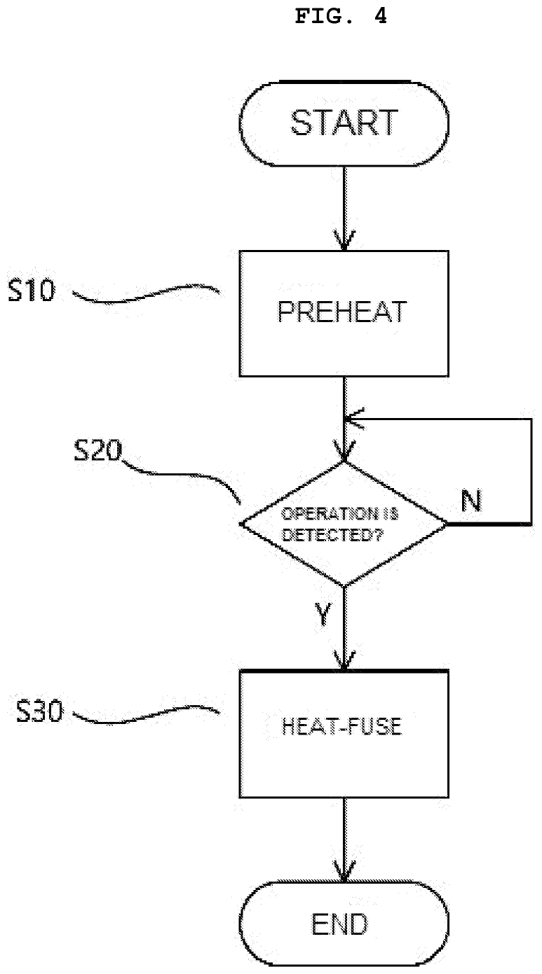

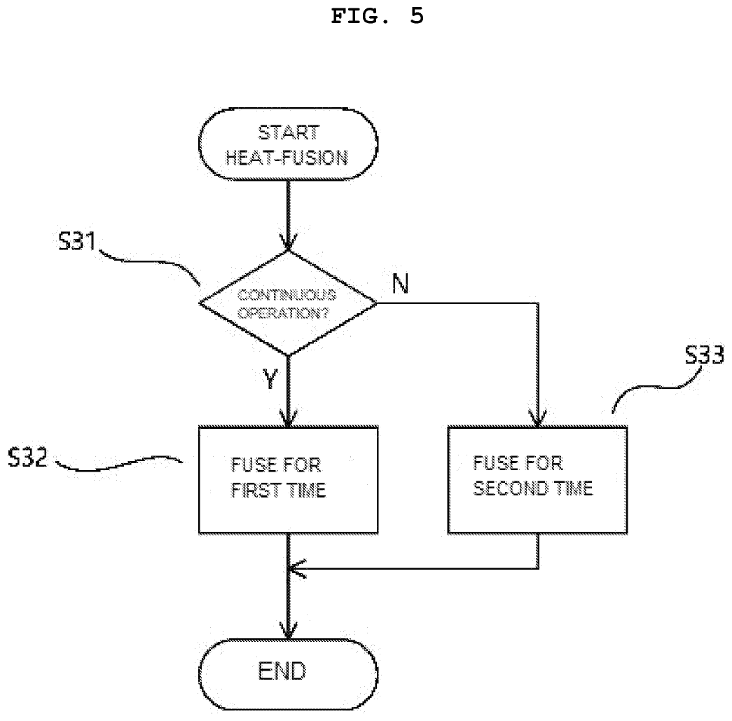

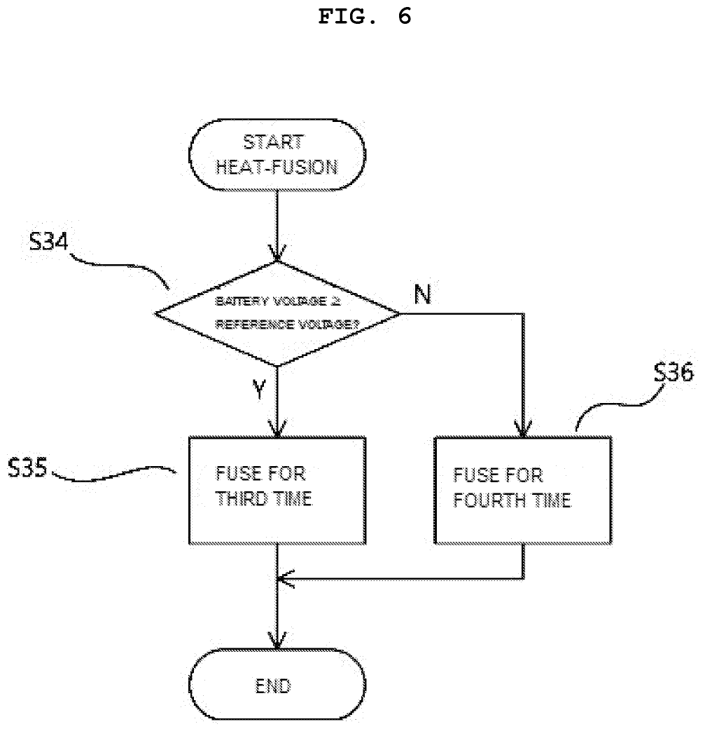

FIG. 3 is a block diagram illustrating the control module 730 of the power supply device 700, FIG. 4 is a flowchart illustrating a control method of a heat fusion-type horticultural binder, and FIGS. 5 and 6 are a flowchart specifically illustrating a heat-fusion operation.

Referring to FIG. 3, the control module 730 of the power supply device 700 may include a battery 734, a power conversion unit 735 generating power for a heating wire to be supplied to the fusion heating wire 340 from the battery 734, a heating wire driving unit 736 controlled to supply the generated power for a heating wire to the fusion heating wire 340 or block the power supply, and a controller 731 controlling the heating wire driving unit 736 to supply power for a heating wire to the fusion heating wire 340 for a predetermined fusion time during the binding operation. In addition, the control module 730 may further include a charging unit 733 capable of charging the battery 734 using an external power source.

The battery 734 may be a primary battery capable of supplying DC power or may be a secondary battery capable of charging and discharging. Hereinafter, a case in which the battery 734 of the present disclosure is a secondary battery built in a horticultural binder and may be charged by the charging unit 733 will be described as an example.

The power conversion unit 735 is a component generating power for a heating wire to be supplied to the fusion heating wire 340 from the battery 734 [symbol] and may be a DC-DC converter capable of converting DC power from the battery 734 into a DC voltage or current having a desired magnitude. The power conversion unit 735 may be configured to output a fixed voltage or current, but may also be configured to vary voltage or current under the control of the controller 731.

The heating wire driving unit 736 is a component controlled to supply or cut off power for a heating wire generated by the power conversion unit 735 to the fusion heating wire 340, and may be a semiconductor switching element or a relay which is electrically turned on and off. The heating wire driving unit 736 may be turned on for a predetermined fusion time only when the operator presses the handle 610 to perform a binding operation, to heat the fusion heating wire 340, thereby efficiently using the battery 734 and the fusion heating wire 340 to increase the number of times of binding per charge and the life of the fusion heating wire 340.

The controller 731 may control the heating wire driving unit 736 to supply power for a heating wire to the fusion heating wire 340 for a predetermined fusion time during the binding operation. In addition, the controller 731 may preheat the fusion heating wire 340 by supplying power for a heating wire to the fusion heating wire 340 during a predetermined preheat time before a full-scale binding operation after the power switch 720 is turned on. In this manner [symbol] by preheating the fusion heating wire 340 after turning on the power, it is possible to prevent the fusion time from being prolonged or the fusion strength of the tape T from being degraded at the time of an initial binding operation.

Referring to FIG. 4, the heat fusion-type horticultural binder according to the present disclosure may be controlled by a control method including a preheating operation (S10) of performing preheating by supplying power for a heating wire to the fusion heating wire 340 for a predetermined preheat time after the power switch 720 is turned on, a binding operation detecting operation (S20) of detecting a binding operation in which the handle frame 100 and the arm 400 are pressed, and a heat fusion operation (S30) of heat-fusing the tape T by supplying power for a heating wire to the fusion heating wire 340 for a predetermined fusion time during the binding operation when it is determined that the binding operation takes place according to a detection result of the binding operation.

In addition, the heat-fusion type horticultural binder according to the present disclosure may perform the heat fusion operation (S30) by setting a fusion time to be different based on whether the binding operation is continuously performed and a remaining capacity of the battery 734.

Referring to FIG. 5, when the binding operation and a previous binding operation are continuous operations having a time interval equal to or less than a reference time, the controller 731 of the present disclosure may control the heating wire driving unit 736 to supply power for a heating wire to the fusion heating wire 340 for a first time. In addition, when the binding operation and the previous binding operation are not continuous operations, the controller 731 may control the heating wire driving unit 736 to supply power for a heating wire to the fusion heating wire 340 for a second time longer than the first time.

If the current binding operation is a continuous operation, since a small amount of heat still remains in the fusion heating wire 340 to be heated by the previous binding operation [symbol] the same fusion strength may be obtained even if the fusion time for the current bonding operation is set to be shorter than that of the case of non-continuous operation.

In other words, in the control method of the heat-fusion type horticultural binder according to the present disclosure, the heat welding operation (S30) may include a continuous operation determining operation (S31) of determining whether the binding operation and the previous binding operation are continuous operations having a time interval less than the reference time, a first time fusion operation (S32) of heat-fusing the tape T by supplying power for a heating wire to the fusion heating wire 340 for the first time when the binding operation and the previous binding operation are continuous operations, and a second time fusion operation (S33) of heat-fusing the tape T by supplying power for a heating wire to the fusing heating wire 340 for a second time longer than the first time when the binding operation and the previous binding operation are not continuous operations.

Also, referring to FIG. 6, the controller 731 of the present disclosure may detect a voltage or remaining capacity of the battery 734 and, when the voltage or remaining capacity of the battery 734 is greater than or equal to a reference voltage or a reference remaining capacity, the controller 731 may control the heating wire driving unit 736 to supply power for a heating wire to the fusion heating wire 340 for a third time. In addition [symbol] when the voltage or remaining capacity of the battery 734 is less than the reference voltage or the reference remaining capacity, the controller 731 may control the heating wire driving unit 736 to supply power for a heating wire to the fusion heating wire 340 for a fourth time longer than the third time.

In other words, in the control method of the heat-fusion type horticultural binder according to the present disclosure based on FIG. 6, the heat fusion operation (S30) may include a battery voltage determining operation (S34) of detecting whether the voltage of the battery 734 is greater than or equal to the reference voltage, a third time fusion operation (S35) of heat-fusing the tape T by supplying power for a heating wire to the fusion heating wire 340 for a third time when the voltage of the battery 734 is equal to or greater than the reference voltage, and a fourth time fusion operation (S36) of heat-fusing the tape T by supplying power for a heating wire to the fusion heating wire 340 for a fourth time longer than the third time when the voltage of the battery 734 is less than the reference voltage.

When the voltage or remaining capacity of the battery 734 is lowered below the reference voltage or the remaining capacity due to repeated use, a temperature of the fusion heating wire 340 may be lowered to degrade the fusion strength of the tape T even though power for a heating wire is applied to the fusion heating wire 340 for the same time. Therefore, in the case of using the above control method, when the voltage or remaining capacity of the battery 734 is lowered below the reference voltage or the remaining capacity, the fusion heating wire 340 may be driven for a longer time than in other cases, thereby preventing a degradation of the fusion strength.

In addition [symbol] the controller 731 of the present disclosure may set the fusion time considering whether the binding operation is a continuous operation and both the voltage and remaining capacity of the battery 734. For example, when the voltage of the battery 734 is equal to or greater than the reference voltage or the reference remaining capacity, the controller 731 of the present disclosure may control the heating wire driving unit 736 to supply power for a heating wire to the fusion heating wire 340 for the third time, and when the voltage or remaining capacity of the battery 734 is less than the reference voltage or the reference remaining capacity, the controller 731 may control the heating wire driving unit 736 to supply power for a heating wire to the fusion heating wire 340 for a fourth time longer than the third time, and here, the third time may be set to be the same as the first time when the binding operation is a continuous operation, and may be set be the same as the second time when the binding operation is not a continuous operation.

According to the control method, the first time, which is a fusion time in a state in which the voltage and remaining capacity of the battery 734 is greater than or equal to the reference value and the binding operation is a continuous operation, may be set as the shortest time, and the fourth time, which is a fusion time in a state in which the voltage and remaining capacity of the battery 734 is less than the reference value and the binding operation is not a continuous operation, may be set as the longest time.

The heat-fusion type horticultural binder according to the present disclosure adjusts a length of the fusion time for which power for a heating wire applied to the fusion heating wire 340 is applied [symbol] rather than sensing a temperature of the fusion heating wire 340 and controlling a magnitude of power for a heating wire to maintain the sensed temperature constantly, to obtain a certain quality of fusion strength in the heat fusion of the tape T. This is based on the fact that most of the horticultural work is done during a season in which plants grow so temperature deviations in the working environment are not extreme, and has the advantage of simplifying a hardware structure and control method rather than the method of checking the temperature of the heating wire.

To this end, the heat-fusion type horticultural binder according to the present disclosure may further include a timer 732 controlled to count the fusion time and preheating time described above in the control module 730. The timer 732 may be configured separately from the controller 731 or may also be built in a micro controller unit (MCU) used as the controller 731.

In addition, in order to constantly manage the temperature of the fusion heating wire 340 during the fusion operation, the controller 731 may control the power conversion unit 735 to set the magnitude of power for a heating wire according to a resistance value of the fusion heating wire 340 or may control the timer 732 to set a fusion time according to a resistance value of the fusion heating wire 340 alternatively or additionally. That is, when the fusion heating wire 340 having a larger resistance value is used, it may be considered to further increase the magnitude of power for a heating wire or set the fusion time to be longer alternatively or additionally in order to generate the same heat or obtain the same fusion strength.

In other words, the heat-fusion type horticultural binder according to the present disclosure may be controlled by the control method including a resistance value measuring operation of measuring a predetermined resistance value of the fusion heating wire 340 and a power setting operation of setting a magnitude of power for a heating wire according to a resistance value of the fusion heating wire 340 or including a fusion time setting operation of setting a fusion time according to a resistance value of the fusion heating wire 340 alternatively or additionally.

Through the configuration described above, the heat fusion-type horticultural binder and the control method thereof according to the present disclosure may increase the speed of the binding operation [symbol] uniformly maintain the binding strength, and minimize the use of the battery 734 per binding operation by adjusting time for supplying power to the fusion heating wire 340 according to tape binding operation conditions.

In the above, the present disclosure has been described and illustrated based on embodiments for illustrating the principles of the present disclosure, but the present disclosure is not limited to the configuration and operation as shown and described. Those skilled in the art to which the present disclosure pertains will be able to understand that the present disclosure may be embodied in other specific forms without changing the technical spirit or essential features of the present disclosure. Therefore, the embodiments described above should be understood as being illustrative in all aspects and not restrictive. The scope of the present disclosure is described in detail in the following claims, and all changes or modifications derived from the meaning, scope, and equivalent concept of the claims should be construed as falling within the scope of the present disclosure.

What is claimed is:

1. A heat fusion-type horticultural binder including a handle frame [symbol] a tape guide attached to the handle frame and including a tape container in which a tape is mounted, a taper rotatably installed on the handle frame and including a fusion heating wire unit including a fusion heating wire receiving a constant current from a power supply device, an arm rotatably installed on the handle frame and including a clincher installed at an end portion facing the taper, and a head installed in the arm and catching and drawing out the tape, comprising:
an operation sensor detecting a binding operation in which the handle frame and the arm are pressed; and
the power supply device controlled to supply power for a heating wire to the fusion heating wire during the binding operation detected by the operation sensor,
wherein the power supply device includes a control module including a power conversion unit generating power for a heating wire to be supplied to the fusion heating wire from a battery, a heating wire driving unit controlled to supply the generated power for a heating wire to the fusion heating wire or cut off the generated power for a heating wire, and a controller controlling the heating wire driving unit to supply power for a heating wire to the fusion heating wire for a predetermined fusion time during the binding operation.

2. The heat fusion-type binding device of claim 1, wherein,
when the binding operation and a previous binding operation are continuous operations having a time interval less than a reference time,
the controller controls the heating wire driving unit to supply power for a heating wire to the fusion heating wire for a first time [symbol] and
when the binding operation and the previous binding operation are not the continuous operations, the controller controls the heating wire driving unit to supply power for a heating wire to the fusion heating wire for a second time longer than the first time.

3. The heat fusion-type binding device of claim 1, wherein,
when a voltage of the battery is equal to or greater than a reference voltage, the controller controls the heating wire driving unit to supply power for a heating wire to the fusion heating wire for a third time, and
when the voltage of the battery is less than the reference voltage, the controller controls the heating wire driving unit to supply power for a heating wire to the fusion heating wire for a fourth time longer than the third time.

4. The heat fusion-type binding device of claim 2, wherein
when a voltage of the battery is equal to or greater than a reference voltage, the controller controls the heating wire driving unit to supply power for a heating wire to the fusion heating wire for a third time, and
when the voltage of the battery is less than the reference voltage, the controller controls the heating wire driving unit to supply power for a heating wire to the fusion heating wire for a fourth time longer than the third time,
wherein the third time is the first time when the binding operation is a continuous operation, and the third time is the second time when the binding operation is not a continuous operation.

5. The heat fusion-type binding device of claim 1 [symbol] wherein
the power supply device further includes:
an electric wire electrically connecting the control module to the fusion heating wire; and
a power switch turning on the power supply device,
wherein the controller supplies power for a heating wire to the fusion heating wire for a predetermined preheating time after the power switch is turned on.

6. The heat fusion-type binding device of claim 5, wherein
the control module further includes a timer controlled to count the fusion time and preheating time.

7. The heat fusion-type binding device of claim 1, wherein
the taper includes:
a tapered frame including a holder recess on one side;
a fusion heating wire unit including the fusion heating wire receiving power for a heating wire from the power supply device; and
a holder, to which the fusion heating wire unit is detachably coupled, inserted into the holder recess,
wherein the fusion heating wire faces the clincher and fuses the tape at both ends introduced between the fusion heating wire and the clincher by heat.

8. The heat fusion-type binding device of claim 1, wherein
the fusion heating wire has a predetermined resistance value, and
the controller controls the power conversion unit to set a magnitude of the power for a heating wire according to the resistance value of the fusion heating wire.

9. The heat fusion-type binding device of claim 6, wherein
the fusion heating wire has a predetermined resistance value [symbol] and
the controller controls the timer to set the fusion time according to the resistance value of the fusion heating wire.

10. A method for controlling the heat fusion-type horticultural binder of claim 1 [symbol] the method comprising:
a binding operation detecting operation of detecting a binding operation in which the handle frame and the arm are pressed; and
a heat fusion operation of thermally heat-fusing the tape by supplying power for a heating wire to the fusion heating wire for the predetermined fusion time during the bonding operation according to a detection result of the bonding operation.

11. The method of claim 10 [symbol] wherein
the heat fusion operation includes:
a continuous operation determining operation of determining whether the binding operation and a previous binding operation are continuous operations having a time interval less than or equal to a reference time;
a first time fusion operation of heat-fusing the tape by supplying power for a heating wire to the fusion heating wire for a first time when the binding operation and the previous binding operation are continuous operations; and
a second time fusion operation of heat-fusing the tape by supplying power for a heating wire to the fusion heating wire for a second time longer than the first time when the binding operation and the previous binding operation are not continuous operations.

12. The method of claim 10 [symbol] wherein
the heat fusion operation includes:
a battery voltage determining operation of detecting whether a voltage of the battery is greater than or equal to a reference voltage;
a third time fusion operation of heat-fusing the tape by supplying power for a heating wire to the fusion heating wire for a third time when the voltage of the battery is equal to or greater than the reference voltage; and
a fourth time fusion operation of heat-fusing the tape by supplying power for a heating wire to the fusion heating wire for a fourth time longer than the third time when the voltage of the battery is less than the reference voltage.

13. The method of claim 11 [symbol] wherein
the heat fusion operation includes:
a battery voltage determining operation of detecting whether a voltage of the battery is greater than or equal to a reference voltage;
a third time fusion operation of heat-fusing the tape by supplying power for a heating wire to the fusion heating wire for a third time when the voltage of the battery is equal to or greater than the reference voltage; and
a fourth time fusion operation of heat-fusing the tape by supplying power for a heating wire to the fusion heating wire for a fourth time longer than the third time when the voltage of the battery is less than the reference voltage [symbol]
wherein the third time is the first time when the binding operation is a continuous operation, and the third time is the second time when the binding operation is not a continuous operation.

14. The method of claim 10, wherein
the power supply device further includes:
an electric wire electrically connecting the control module to the fusion heating wire; and
a power switch turning on the power supply device,
wherein the method further includes:
a preheating operation of preheating by supplying power for a heating wire to the fusion heating wire for a predetermined preheating time after the power switch is turned on.

15. The method of claim 10, further comprising:
a resistance value measuring operation of measuring a predetermined resistance value of the fusion heating wire; and
a power setting operation of setting a magnitude of the power for a heating wire according to the resistance value of the fusion heating wire.

16. The method of claim 10, further comprising:
a resistance value measuring operation of measuring a predetermined resistance value of the fusion heating wire; and
a fusion time setting operation of setting the fusion time according to the resistance value of the fusion heating wire.
